(19) United States
(12) Patent Application Publication
(10) Pub. No.: US 2003/0033221 A1
(43) Pub. Date: Feb. 13, 2003

(54) Electronic shop management system

(76) Inventors: Tetsuji Fuwa, Gifu (JP); Tsuyoshi Ogawa, Aichi (JP)

Correspondence Address: Oliff & Berridge, PO Box 19928, Alexandria, VA, 22320, US

(21) Appl. No.: 10/204,666

(22) PCT Filed: Dec. 25, 2001
(86) PCT No.: PCT/JP01/11333

(30) Foreign Application Priority Data
Dec. 28, 2000 (JP) 2000-402798

(51) Int. Cl. G06F 17/60

(52) U.S. Cl. 705/27

(57) ABSTRACT

Templates common to stamp suppliers are stored in a common template database and stamp supplier's original templates are stored in an original template database. Templates offered in common to the stamp suppliers and the original templates of a stamp supplier stored in the original template database are seamlessly displayed together on Web browsers of purchaser computers. Therefore, the suppliers who open virtual stores in an electronic shopping mall can readily construct the virtual stores, and further be differentiated from other suppliers.

### BACKGROUND OF THE INVENTION

1. Field of the invention

The invention relates to an online store management system that performs data communication, via a communication network, between a communication terminal of one or a plurality of supplier(s) and a communication terminal of a purchaser who buys a product.

2. Description of the Related Art

Recently, in association with developments in computer network technology, in which the Internet is a representative example, GUI (graphical user interface) based electronic transactions using the WWW (World Wide Web), especially mail-order business between retailers and consumers, are actively performed. By using the WWW for the mail-order business, purchasers benefit because they can buy products promptly with a feeling of being safe after checking sample images of many products on a Web browser. Sellers benefit because they can receive orders cheaply from a broad geographic range of consumers.

As one form of the above-described mail-order business using the WWW, there is an electronic shopping mall to which one or a plurality of supplier(s) join. In such an electronic shopping mall, to enable a purchaser of a product to readily access to a top page of a virtual store of respective suppliers and Web pages including sample images and prices of products that the respective suppliers sell, generally links to these Web pages from a specific Web page that an administrator of the electronic shopping mall manages, are provided in HTML (Hyper Text Markup Language).

In a case where the electronic shopping mall may include a plurality of virtual stores of suppliers that sell the same kinds of products (including a case where the electronic shopping mall is only made up of a virtual store of one or more suppliers that sell the same kinds of products), if the administrator of the electronic shopping mall offers sample images of the products that these suppliers handle, the suppliers can readily perform construction of the Web pages for their own virtual stores.

### SUMMARY OF THE INVENTION

However, with this structure, the Web pages of the virtual stores of a plurality of suppliers that handle the same kinds of products only include identical sample images offered by the administrator. Therefore, it is difficult for the suppliers to appeal the features of their own virtual stores to the purchasers, and it is impossible for the purchasers to find originality of the virtual store of each supplier, with respect to their product configuration.

Accordingly, it is an object of the invention is to provide an online store management system that enables suppliers who join an electronic shopping mall to readily construct Web pages for their own virtual stores and to enable the virtual stores of each of the suppliers to have originality.

To achieve the above-described objectives, there is provided an online store management system for providing data on products that one supplier or a plurality of suppliers sell, to a communication terminal of a purchaser through a communication network. The online store management system of the invention includes a common data storing means that stores common data on the products that are commonly sold by the plurality of the suppliers, an original data storing means that stores original data on the products that are originally sold by each supplier, a setting condition storing means that updatably stores setting conditions of the common data, the products associated with the common data, the original data, and the products associated with the original data, for the each supplier, and an editing means that edits data to be transmitted to the communication terminal of the purchaser, based on settings stored in the setting condition storing means.

According to the invention, it is very convenient for suppliers to be able to readily accomplish Web pages for their own virtual stores using the common data, and further, for each supplier to be able to have their own originality different from other suppliers' using the original data, so as to be differentiated from other suppliers.

In the invention, any well-known networks such as the Internet, LAN (Local Area Network), and WAN (Wide Area Network) may be used as the communication network.

### BRIEF DESCRIPTION OF THE DRAWINGS

FIG. 1 is a block diagram showing an online store management system according to an embodiment of the invention;

FIG. 2 is a flowchart showing new registration processes for original templates and registered information changing processes for templates, in terms of server operations;

FIG. 3 is a flowchart showing the new registration processes for original templates and registered information changing processes for templates, in terms of server operations;

FIG. 4 is a schematic view showing an example of a screen displayed in a browser of a client in one step of the new registration processes for original templates and registered information changing processes for templates;

FIG. 5 is a schematic view showing an example of a screen displayed in the browser of the client in one step of the new registration processes for original templates and registered information changing processes for templates;

FIG. 6 is a schematic view showing an example of a screen displayed in the browser of the client in one step of the new registration processes for original templates and registered information changing processes for templates;

FIG. 7 is a schematic view showing an example of a screen displayed in the browser of the client in one step of the new registration processes for original templates and registered information changing processes for templates;

FIG. 8 is a schematic view showing an example of a screen displayed in the browser of the client in one step of the new registration processes for original templates and registered information changing processes for templates;

FIG. 9 is a schematic view showing an example of a screen displayed in the browser of the client in one step of the new registration processes for original templates and registered information changing processes for templates;

FIG. 10 is a flowchart showing template information page displaying processes in terms of server operations;

FIG. 11 is a schematic view showing an example of a screen displayed in a browser of a client in one step of the template information page displaying processes;

FIG. 12 is a schematic view showing an example of a screen displayed in the browser of the client in one step of the template information page displaying processes;

FIG. 13 is a schematic view showing an example of a screen displayed in the browser of the client in one step of the template information page displaying processes;

FIG. 14 is a flowchart showing stamp ordering processes in terms of server operations;

FIG. 15 is a schematic view showing an example of a screen displayed in the browser of the client in one step of the stamp ordering processes; and

FIG. 16 is a schematic view showing an example of a screen displayed in the browser of the client in one step of the stamp ordering processes.

### DETAILED DESCRIPTION OF THE EMBODIMENT

A preferred embodiment of the invention will be described with reference to the drawings.

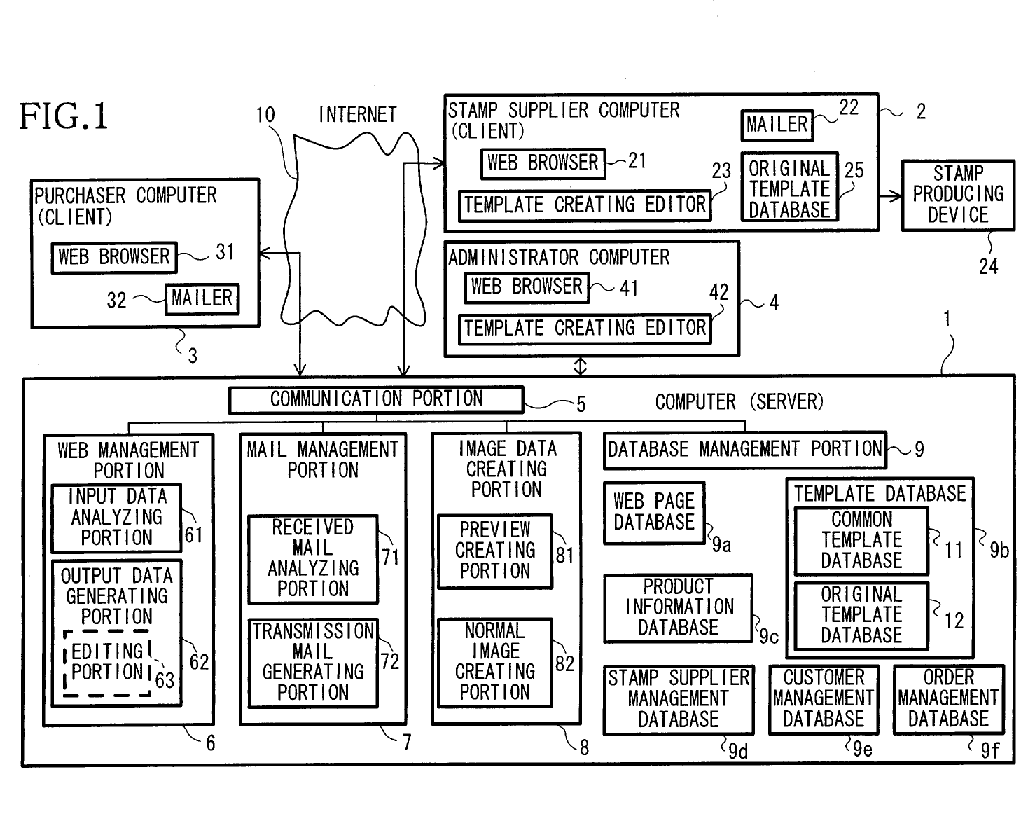

FIG. 1 is a block diagram showing a stamp sales system which is an online store management system according to an embodiment of the invention. In the system, stamps with stamp faces offered by a system administrator, as well as with stamp suppliers' original stamp faces are provided to consumers (purchasers) by the stamp suppliers who open virtual stores in an electronic shopping mall. The stamp sales system includes a computer 1 that functions as a server, a stamp supplier computer 2 that is a client of the computer 1, a stamp purchaser computer 3 that is also a client of the computer 1, and an administrator computer 4 that performs system controls for the computer 1. The computers 1, 2, 3 are connected to each other to enable mutual data communication through the Internet 10. Although FIG. 1 shows only one client computer 2 and one client computer 3, all stamp supplier and stamp purchaser computers connected to the Internet 10 could be clients.

The server computer 1 includes a communication portion 5 that performs data transmission and reception with the computers 2, 3, using a protocol conforming with the Internet 10, a Web management portion 6 that manages transmission and reception of a Web page written in a HTML (Hyper Text Markup Language) via the Internet 10 using a HTTP (Hyper Text Transfer Protocol), a mail management portion 7 that manages transmission and reception of mail written in the HTML and/or text, via the Internet 10 using a SMTP (Simple Mail Transfer Protocol) and a POP (Post Office Protocol), an image data creating portion 8 that creates preview image data for a stamp face, a database management portion 9 that manages databases 9a, 9b, 9c, 9d, 9e, 9f, which are described below, a Web page database 9a that stores HTML files for Web pages to be transmitted to the computers 2, 3, a template database 9b that stores files concerning stamp face designs (templates), a product information database 9c that stores information about products, such as product ink colors, a stamp supplier management database 9d that stores information about stamp supplies who are registered in the server, a customer management database 9e that stores information about customers who have ordered in the past, and an order management database 9f that stores information about status of orders from customers.

The Web management portion 6 includes an input data analyzing portion 61 and an output data generating portion 62. The input data analyzing portion 61 analyzes a content of data supplied through the communication portion 5, via the Internet 10, based on the HTTP. The output data generating portion 62 generates, using a CGI (Common Gateway Interface) application, HTML data that is transmitted from the communication portion 5 based on the HTTP and supplied to the computers 2, 3, in accordance with the analysis results of the input data analyzing portion 61. The output data generating portion 62 includes an editing portion 63. The editing portion 63 creates a template information page for showing templates, using various templates stored in the template database 9b.

The mail management portion 7 includes a received mail analyzing portion 71 and a transmission mail generating portion 72. The received mail analyzing portion 71 analyzes contents of email messages supplied through the communication portion 5 to the mail management portion 7, via the Internet 10, based on the POP. The transmission mail generating portion 72 generates email messages that are supplied through the communication portion 5 to the computers 2, 3, based on the SMTP.

The image data creating portion 8 includes a preview creating portion 81 and a normal image creating portion 82. The preview creating portion 81 creates preview image data on a stamp face, at approximately 90 dpi, by changing the address, name, and the like written on a stamp face of a template designated by a customer, to the address, name, and the like designated by the customer. The normal image creating portion 82 creates normal image data to be used when a stamp supplier produces a stamp, at approximately 600 dpi. In other words, the preview image created by the preview creating portion 81 is showed to the supplier or the purchaser as a thumbnail that is smaller and simpler than a normal image. Accordingly, the communication time between the server, and the supplier or the purchaser can be reduced when compared with the time when a high-resolution normal image is transmitted.

The database management portion 9 extracts required data from the Web page database 9a, the template database 9b, the product information database 9c, the stamp supplier management database 9d, the customer management database 9e, and the order management database 9f. The database management portion 9 controls rewriting in each database 9a, 9b, 9c, 9d, 9e, 9f.

The Web page database 9a stores HTML files that are transmitted to the purchaser computer 3 and displayed by a Web browser 31, and HTML files that are transmitted to the stamp supplier computer 2 and displayed by a Web browser 21. The HTML files stored in the Web page database 9a may be rewritten by the output data generating portion 62 of the Web management portion 6, as necessary.

The template database 9b includes a common template database (common data storing means) 11 and an original template database (original data storing means) 12. The common template database 11 stores templates offered by the system administrator in common to stamp suppliers who open virtual stores in an electronic shopping mall (hereinafter such templates are referred to as the “common templates”). The common template database 11 is provided with a function as a setting condition storing means for updateably storing various setting conditions of the common templates. The common template database 11 is classified broadly into categories (such as business, personal, seasonal, and family). Each category is classified into sub-categories (e.g., office and sales for the business category). Information about templates (such as sample images of stamp faces (including ink colors and fonts) and sizes) is stored in areas of the sub-categories in each category, in association with predetermined template numbers (e.g., A-02 and A-03).

The original template database 12 stores original templates of the stamp suppliers opening the virtual stores in the electronic shopping mall. The original template database 12 is provided with a function as a setting condition storing means for updatably storing various setting conditions of the original templates. The original template database 12 is classified broadly into categories. Each category is classified into sub-categories. Information about templates (such as sample images of stamp faces (including ink colors and fonts) and sizes) is stored in areas of the sub-categories in each category, in association with suppliers IDs, which serve as identifiers, and the template numbers.

The product information database 9c is classified broadly into categories. Each category is classified into sub-categories. Product information about products (such as stamp face sizes, grip colors, ink colors, and sales prices) is stored in areas of the sub-categories in each category, in association with a supplier and template. In other words, the product information database 9c updatably stores, for each of the suppliers, setting conditions of products associated with the common templates and products associated with the original templates. Therefore, the template database 9b and the product information database 9c constitute the setting condition storing means.

The stamp supplier management database (supplier ID storing means) 9d stores the name of a stamp supplier, name of a person in charge, address, telephone number, and password, in association with an ID serving as an identifier of the stamp supplier who is registered in the server. When a new stamp supplier is to be registered in the server, the database management portion 9 adds and registers the stamp supplier in the stamp supplier management database 9d, with the ID of the stamp supplier who is newly registered, being associated with the password and the like.

The customer management database 9e stores information about customers who have ordered in the past (such as name, age, gender, and address), in association with IDs, which serve as identifiers for the customers. When a new customer who has not placed an order in the past, orders, the database management portion 9 adds and registers the customer in the customer management database 9e, with the ID of the new customer being associated with the customer information. As the customer information to be stored in the customer management database 9e, information that indicates whether a customer caused any troubles in the past when the customer purchases a product, may be added. Such information is stored as blacklist data. As the customer IDs, email addresses that the customers have may be adopted. This can save the server from having to issue the IDs. Further, the customer IDs and email addresses do not have to be stored redundantly. As the customer IDs and passwords, a cookie file that is transmitted from the server computer 1 and stored in the purchaser computer 3, may be used. This can save purchasers from having to input the IDs and passwords.

The order management database 9f stores each order number and information about an order (such as date ordered, product number, and dispatched or not), in association with each other. When a new order of a product is placed, the database management portion 9 adds and registers information about the order in the order management database 9f, in association with the order number.

The client supplier computer 2 is installed with an original template database 25, the browser 21, which is Web viewing software, and a mailer 22, which is mail transmission and reception software, as well as a template creating editor 23 for a stamp supplier who is an owner of the computer 2 to create templates for their own stamp faces. The computer 2 is connected to a stamp producing device 24. The stamp producing device 24 is for producing a stamp with characters and the like on a stamp face corresponding to the order received from the computer 3 through the computer 1. When a stamp is produced using the stamp producing device 24, the normal image data created by the normal image creating portion 82 and downloaded from the computer 1 is used.

The original template database 25 stores the original templates that are originally created by the stamp suppliers who open the virtual stores in the electronic shopping mall and are owners of the computers 2. The original template database 25 is classified broadly into categories. Each category is classified into sub-categories. Information about templates (such as sample images of stamp faces (including ink colors and fonts), sizes, sales prices, and layout frames) is stored in areas of the sub-categories in each category, in association with the template numbers.

The client purchaser computer 3 is installed with the browser 31, which is Web viewing software, and a mailer 32, which is mail transmission and reception software.

The administrator computer 4 is installed with a browser 41, which is Web viewing software, as well as a template creating editor 42 for the system administrator to create templates for stamp faces to be provided to the stamp suppliers who open the virtual stores in the electronic shopping mall.

Next, various processes performed in the online store management system having the above-described structures are described with reference to the drawings.

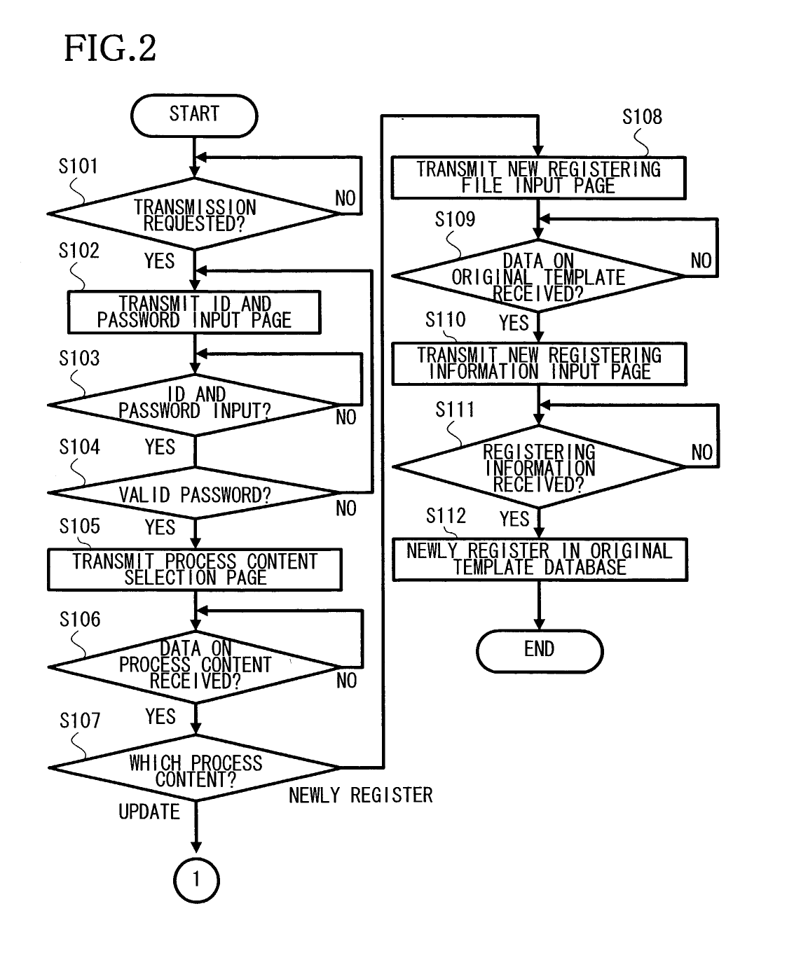

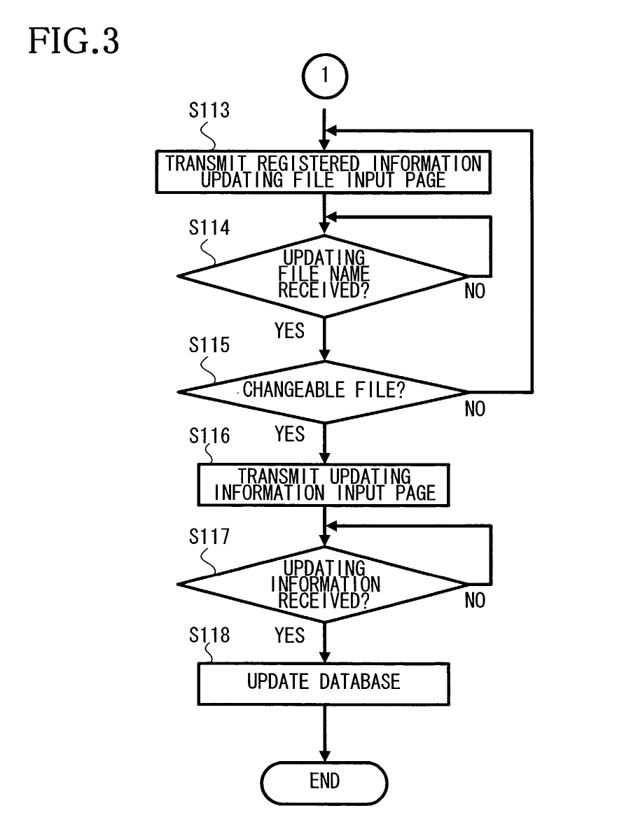

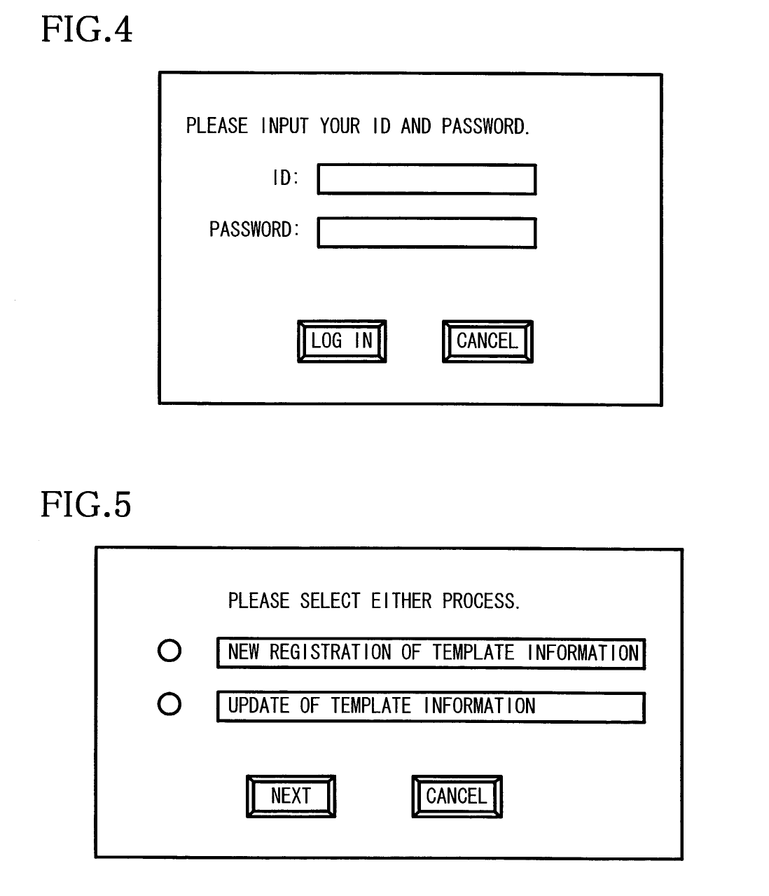

First, new registration processes for original templates and registered information changing processes for templates (including the common templates and original templates) are described with reference FIGS. 2 to 9. FIGS. 2 and 3 are flowcharts representing each of the processes in terms of server operations. Circled FIG. 1 in FIG. 2 is connected, as procedural steps, to circled FIG. 1 in FIG. 3. FIGS. 4 to 9 are examples of pages displayed on the browser 21 of the computer 2 in one step of the respective processes. The new registration processes for original templates will be described first for the sake of expediency, and then the registered information changing processes for templates will be described.

The new registration processes for original templates will be described below. Before the stamp supplier who opens a virtual store in the electronic shopping mall registers their original template in the original template database 12 of the computer 1, the stamp supplier creates their own original template beforehand using the template creating editor 23. The stamp supplier performs an operation to store a file concerning the template in the template database 25 in the computer 2.

In step S101, the input data analyzing portion 61 of the Web management portion 6 determines whether transmission of a Web page for asking a stamp supplier to input an ID and password is requested. When the transmission is requested (S101:YES), flow goes to the process in step S102.

In step S102, a file to display, on the browser 21 of the supplier computer 2, an ID and password input page shown in FIG. 4 is extracted from the Web page database 9a by the database management portion 9, and transmitted from the communication portion 5 to the computer 2.

Accordingly, the ID and password input page is displayed on the Web browser 21 of the computer 2. In the ID and password input page, the stamp supplier inputs the ID and password. After input, the stamp supplier clicks on “LOG IN” button. Accordingly, data on the ID and password is transmitted from the computer 2 to the computer 1.

In step S103, the input data analyzing portion 61 of the Web management portion 6 of the computer 1 determines whether the data on the ID and password is received from the computer 2. When the data on the ID and password is received from the computer 2 (S103:YES), flow goes to the process in step S104.

In step S104, the input data analyzing portion 61 of the Web management portion 6 determines whether the input password is valid, based on the IDs stored in the stamp supplier management database 9d and the passwords associated with the IDs. When it is determined that the password is invalid (S104:NO), flow returns to the process in step S102, and the processes in steps S102 to S104 are performed again. When it is determined that the password is valid (S104:YES), flow goes to the process in step S105.

In step S105, a file to display, on the browser 21 of the supplier computer 2, a process content selection page shown in FIG. 5, is extracted from the Web page database 9a by the database management portion 9, and transmitted from the communication portion 5 to the computer 2.

The process content selection page shown in FIG. 5 is the page for selecting the new registration processes for original templates and the registered information changing processes for templates.

Accordingly, the process content selection page is displayed on the Web browser 21 of the computer 2. The stamp supplier selects a desired process content in the process content selection page, by clicking on the relevant option button (radio button). After selection, the stamp supplier clicks on NEXT button. Accordingly, data indicating the selected process content is transmitted from the computer 2 to the computer 1. For the new registration processes, the stamp supplier clicks on the option button (radio button) associated with the new registration of template information.

In step S106, the input data analyzing portion 61 of the Web management portion 6 determines whether the data indicating the process content is received from the computer 2. When the data on the process content is received from the computer 2 (S106:YES), flow goes to the process in step S107.

In step S107, the input data analyzing portion 61 of the Web management portion 6 of the computer 1 analyzes the data indicating the process content received in the step S106 to determine whether the data is about the new registration of an original template or the update of the template information. When the date indicates the new registration of the template information (S107:NEWLY REGISTER), flow goes to the process in step S108. When the date indicates the update of the template information (S107:UPDATE), flow goes to the process in step S113.

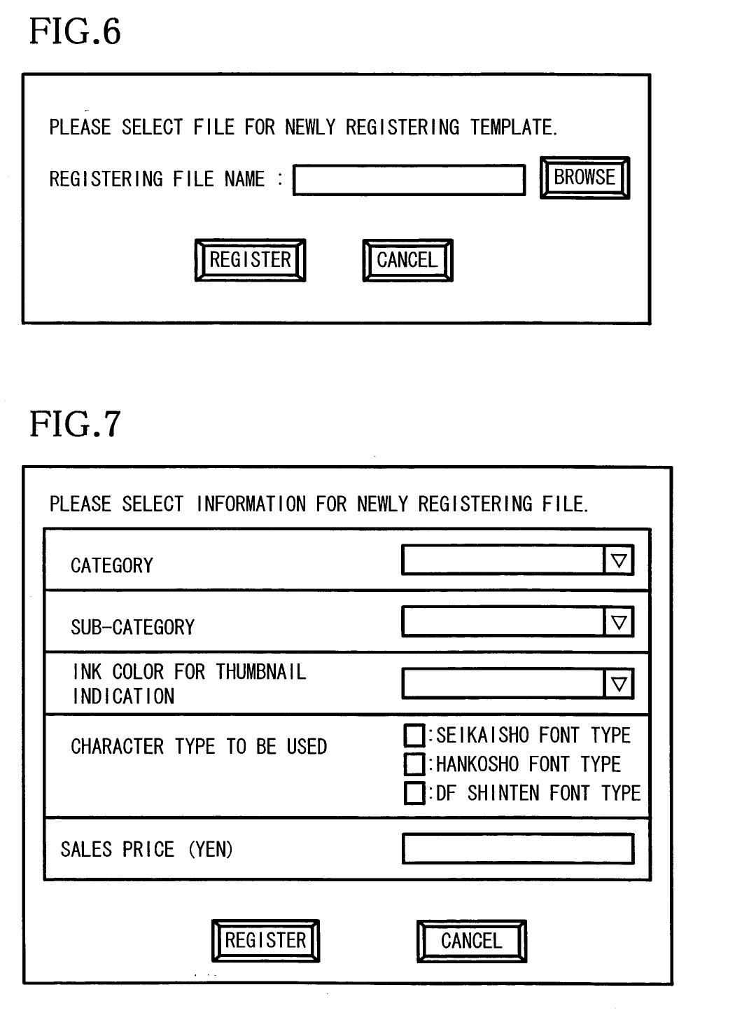

In step S108, a file to display on the browser 21 of the computer 2, a new registering file input page shown in FIG. 6 is extracted from the Web page database 9a by the database management portion 9 and transmitted from the communication portion 5 to the computer 2.

FIG. 6 is an example of the new registering file input page for inputting a file name of an original template to be newly registered. When BROWSE button in FIG. 6 is clicked on, file names of the original templates that have already been stored in the original template database 25, are indicated.

Accordingly, the new registering file input page is displayed on the Web browser 21 of the computer 2. In the new registering file page, the stamp supplier inputs the file name of the template that is to be registered. After input, the stamp supplier clicks on REGISTER button. Accordingly, data on the original template corresponding to the input file name is extracted from the original template database 25. The extracted data is transmitted from the computer 2 to the computer 1. As a file name at the time of transmission, a file name of the original template with the ID of the stamp supplier added is used, to make processing in the computer 2 simplified and make the template owner identifiable.

In step S109, the input data analyzing portion 61 of the Web management portion 6 of the computer 1 determines whether the data on the original template is received from the computer 2. When the data on the original template is received from the computer 2 (S109:YES), flow goes to the process in step S110.

In step S110, a file to display on the browser 21 of the computer 2, a new registering information input page shown in FIG. 7 is extracted from the Web page database 9a by the database management portion 9, and transmitted form the communication portion 5 to the computer 2.

FIG. 7 is an example of the new registering information input page for inputting various information, such as the category of an original template that is to be registered. The new registering information input page includes, as input or selection items, a category, sub-category, ink color for thumbnail indication, character type (font) to be used when the template is indicated, and sales price.

Accordingly, the new registering information input page is displayed on the Web browser 21 of the computer 2. In the new registering information input page, the stamp supplier inputs the category, sub-category, and thumbnail ink color, or selects the category, sub-category, and thumbnail ink color, using the option menu (pull-down menu). One or more character types to be used are selected by clicking on the checkbox(es). Further, the sales price is input. Thereafter, the stamp supplier clicks on REGISTER button. Accordingly, data on various template information, such as the category, is transmitted from the computer 2 to the computer 1.

In step S111, the input data analyzing portion 61 of the Web management portion 6 of the computer 1 determines whether the data on the various information, such as the category, is received from the computer 2. When the data on the various information, such as the category, is received from the computer 2 (S111:YES), flow goes to the process in step S112.

In step S112, the data on the original template (including the setting conditions of the original template) is stored by the database management portion 6 of the computer 1, in association with the file name (file name at the time of storage in the original template database 25 to which the stamp supplier ID added), in the original template database 12 at the area for the sub-category of the category designated by the stamp supplier.

In the above-described new registration processes for the templates, templates that the stamp supplier originally creates, can be stored in the original template database 12 of the server computer 1. In addition, the stamp supplier ID is added to a part of the file name. Therefore, by using the added stamp supplier ID, other stamp supplier's accesses can be restricted.

The registered information changing processes for templates will be described below. Similar to the new registration processes, the processes in steps S101 to S105 are performed for the registered information changing processes for templates. The process content selection page shown in FIG. 5 is displayed on the Web browser 21 of the computer 2. In the process content selection page, the stamp supplier clicks on the option button (radio button) associated with the desired process item. In the registered information updating processes, the stamp supplier clicks on the option button (radio button) associated with the update of the template information.

Subsequently, the processes in steps S106 and S107 are performed similar to the new registration processes. The input data analyzing portion 61 of the Web management portion 6 of the computer 1 analyzes the data indicating the process content received in step S106. In the registered information updating processes, it is determined that the data is about the update of original template information, and flow goes to the process in step S113.

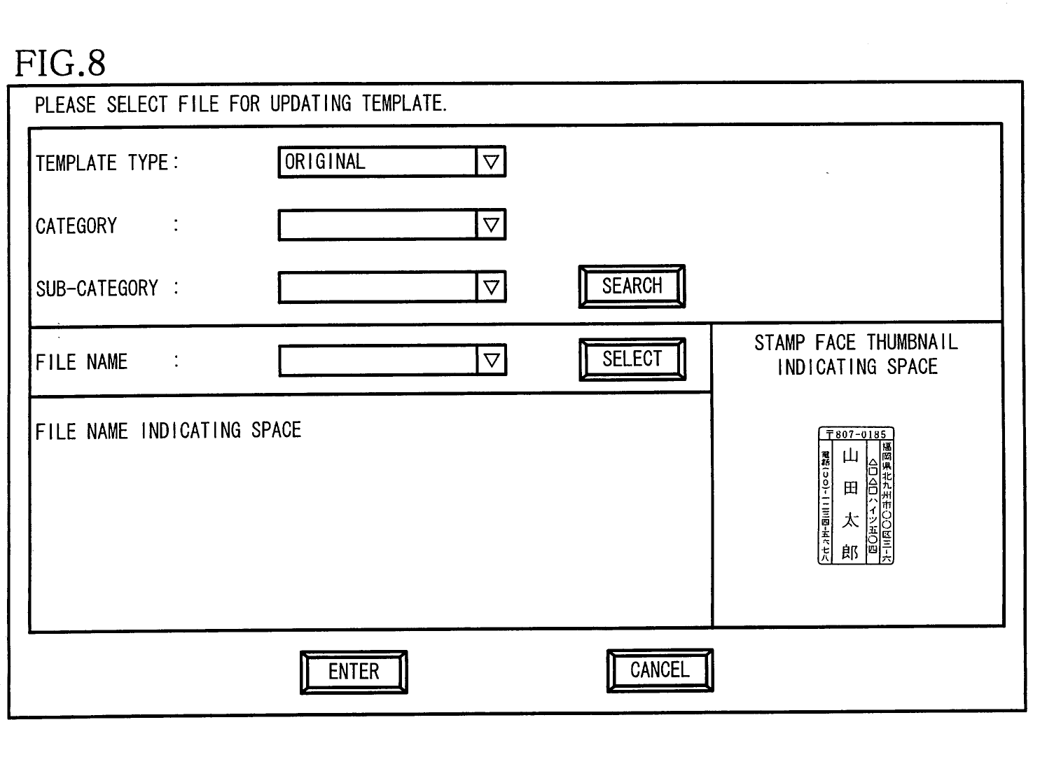

In step S113, a file to display on the browser 21 of the computer 2, a registered information updating file input page shown in FIG. 8 is extracted from the Web page database 9a by the database management portion 9, and transmitted from the communication portion 5 to the computer 2.

FIG. 8 is an example of the registered information updating file input page for inputting a name of a file subject to changes with respect to various template information (such as the category). The registered information updating file input page includes, as input or selection items, the type of template (common templates or original templates) subject to changes, the category and sub-category that the template belongs before change, and the file name. When SEARCH button is clicked on, the file names of the templates included in the input template type, category, and sub-category are listed in the file name indicating space. When SELECT button is clicked on, a stamp face thumbnail in the template corresponding to the input file name is indicated in the stamp face thumbnail indicating space.

Accordingly, the registered information updating file input page is displayed on the Web browser 21 of the computer 2. In the registered information updating file input page, the stamp supplier inputs, or selects using the option menu (pull-down menu), the template type, category, and sub-category for a template whose registered information is to be updated. Further, the name of the file whose registered information is to be updated. Thereafter, the stamp supplier clicks on ENTER button. Accordingly, data on the template whose registered information is to be updated, such as the file name, is transmitted from the computer 2 to the computer 1.

In step S114, the input data analyzing portion 61 of the Web management portion 6 of the computer 1 determines whether the data on the template that is to be updated, such as the file name, is received from the computer 2. When the data, such as the file name, is received from the computer 2 (S114:YES), flow goes to the process in step S115.

In step S115, it is determined whether the file with its name designated by the stamp supplier is such a file whose registered information can be changed by the stamp supplier being engaged in the operation. Such determination is made as to whether the stamp supplier (owner) ID, which is a part of the file name of the original template corresponding to the file name designated by the stamp supplier, matches the ID of the stamp supplier being engaged in the operation. When the file is not changeable (S115:NO), flow returns to the process in S113 and the processes in steps S113 to S115 are performed again. When the file is changeable (S115:YES), flow goes to the process in step S116. When the file designated by the stamp supplier is for the common template, it is determined that the file is changeable, and flow goes to the process in step S116.

By performing the process in step S115, information about original data for each of the stamp suppliers is prevented from being changed by other suppliers.

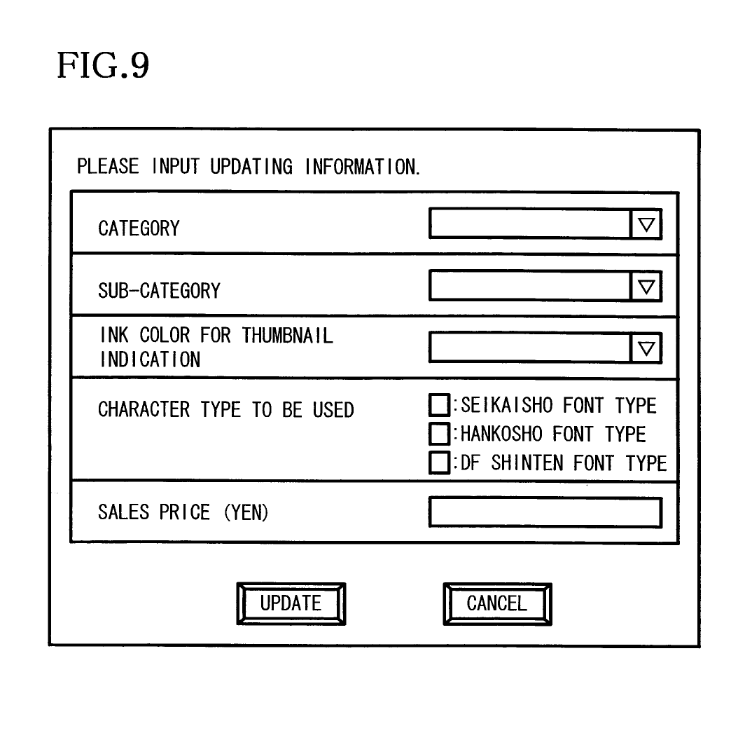

In step S116, a file to display on the browser 21 of the computer 2, an updating information input page shown in FIG. 9 is extracted from the Web page database 9a by the database management portion 9 and transmitted from the communication portion 5 to the computer 2.

FIG. 9 is an example of the updating information input page for changing the various information on a template (such as the category). The updating information input page includes, as input or selection items, a category and sub-category after change, ink color for thumbnail indication, character type to be used, and sales price. Accordingly, the updating information input page is displayed on the Web browser 21 of the computer 2. For the original templates, the stamp supplier inputs the category, sub-category, and thumbnail ink color, or selects using the option menu (pull-down menu) the category, sub-category, and option menu (pull-down menu). One or a plurality of character types to be used are selected by clicking on the checkbox(es), and the sales price is input. For the common templates, the stamp supplier inputs the sales price. Thereafter, the stamp supplier clicks on UPDATE button. Accordingly, data on various updating information, such as the category, is transmitted from the computer 2 to the computer 1.

When the stamp supplier selects the original template in “TEMPLATE TYPE” in the registered information updating file input page shown in FIG. 8, all items can be changed. However, when the stamp supplier selects the common templates, changes to the category, sub-category, thumbnail ink color, and character type to be used are not allowed, but only the change to the sales price is allowed. The information about the common templates may be stored according to the stamp suppliers, in the areas for the sub-categories of the categories in the common template database 11, to allow the stamp suppliers to change various information (category, sub-category, thumbnail ink color, character type to be used, and sales price) about the common templates offered to each of the stamp suppliers.

In step S117, the input data analyzing portion 61 of the Web management portion 6 of the computer 1 determines whether the data on the various updating information, such as the category, is received from the computer 2. When the data on the various updating information, such as the category, is received from the computer 2 (S117:YES), flow goes to the process in step S118.

In step S118, the database management portion 6 of the computer 1 updates the template database 9b and the product information database 9c, based on the various information designated by the stamp supplier.

Through the above-described registered information updating processes, the stamp supplier can change various information, such as the sales price of a stamp associated with a common template and a category to which an original template belongs.

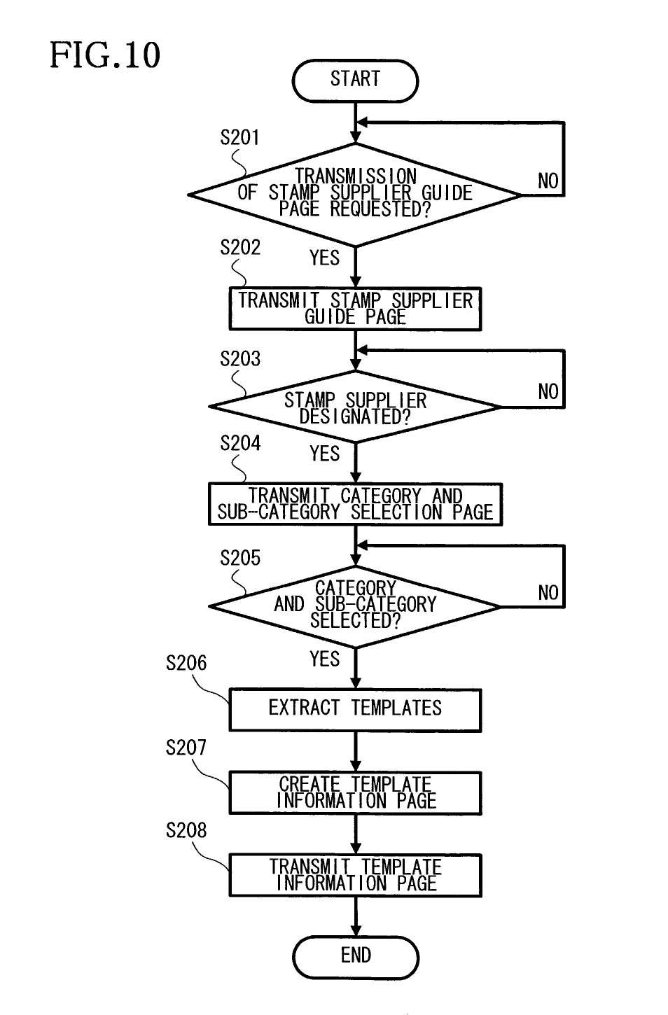

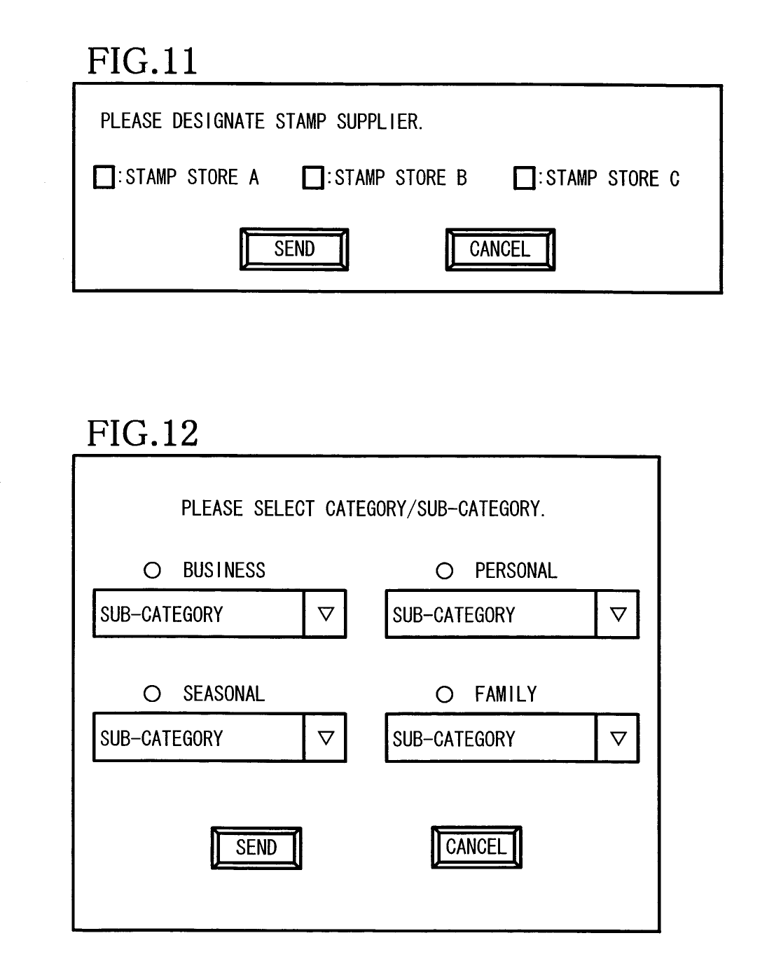

Next, template information page displaying processes for displaying templates that a stamp supplier handles on the Web browser 31 of the purchaser computer 3 will be described with reference to FIGS. 10 to 13. FIG. 10 is a flowchart showing template information page displaying processes in terms of server operations. FIGS. 11 to 13 are schematic view showing examples of pages displayed in the browser 31 of the computer 3 in one step of the template information page displaying processes.

In step S201, the input data analyzing portion 61 of the Web management portion 6 determines whether transmission of a Web page for asking a purchaser to designate a stamp supplier is requested. When the transmission is requested (S201:YES), flow goes to the process in step S202.

In step S202, a file to display, on the browser 31 of the purchaser computer 3, a stamp supplier guide page shown in FIG. 11 is extracted from the Web page database 9a by the database management portion 9, and transmitted from the communication portion 5 to the computer 3.

Accordingly, the stamp supplier guide page is displayed on the Web browser 31 of the computer 3. In the stamp supplier guide page, the purchaser selects a desired stamp supplier by clicking on an option button (radio button) for the stamp supplier. After selection, the purchaser clicks on SEND button. Accordingly, data on the designated stamp supplier is transmitted from the computer 3 to the computer 1.

In step S203, the input data analyzing portion 61 of the Web management portion 6 of the computer 1 determines whether the data on the designated stamp supplier is received from the computer 3. When the information about the stamp supplier is received from the computer 3 (S203:YES), flow goes to the process in step S204.

In step S204, a file to display, on the browser 31 of the computer 3, a category and sub-category selection page shown in FIG. 12, is extracted from the Web page database 9a by the database management portion 9, and transmitted from the communication portion 5 to the computer 3.

Accordingly, the category and sub-category selection page is displayed on the Web browser 31 of the computer 3. In the category and sub-category selection page, the purchaser selects a desired category by clicking on a box associated with the category, as well as a desired sub-category using an option menu (pull-down menu) for the selected category. After selection, the purchaser clicks on SEND button. Accordingly, data on the selected category/sub-category is transmitted from the computer 3 to the computer 1.

In step S205, the input data analyzing portion 61 of the Web management portion 6 of the computer 1 determines whether the data on the selected category/sub-category is received from the computer 3. When the information about the category/sub-category selection is received from the computer 3 (S205:YES), flow goes to the process in step S206.

In step 206, the database management portion 6 of the computer 1 extracts the common templates belonging to the category/sub-category according to the data received in step S205, from the common template database 11, and the original templates of the stamp supplier according to the data received in step S103, and belonging to the category/sub-category according to the data received in step S205, from the original template database 12, based on the stamp supplier ID.

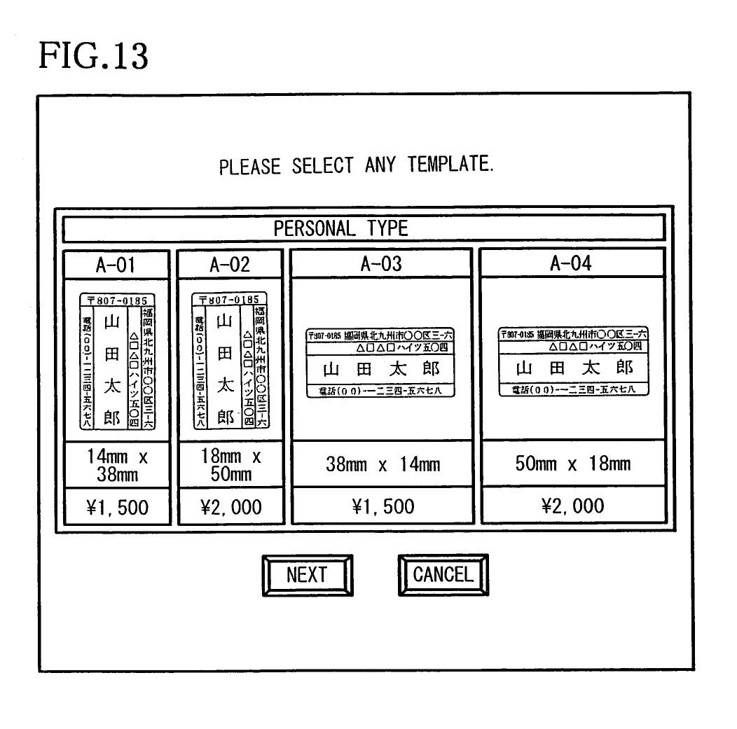

In step S207, the editing portion 63 in the output data generating portion 62 of the computer 1 extracts a template information page from the Web page database 9a. Information about the common templates and the original templates extracted in step S206 is added to the extracted information page to generate HTML data on the template information page shown in FIG. 13.

In step S208, the HTML data to display on the browser 31 of the computer 3, the template information page of the stamp supplier designated by the purchaser is transmitted from the communication portion 5 to the computer 3 by the Web management portion 6. FIG. 13 is an example of the template information page for showing the stamps that the stamp supplier handles to the purchaser. Such a page posts a plurality of products that the stamp supplier handles, as well as a stamp face sample, stamp face size, and sales price of each product.

Through a series of processes in steps S201 to S208, displayed on the Web browser 31 of the purchaser computer 3 is the template information page posting the templates, which belong to the category/sub-category selected by the purchaser and are the common templates offered by the system administrator in common to the stamp suppliers who open the virtual stores in the electronic shopping mall, and are the original templates of the stamp supplier designated by the purchaser. That is, information about the templates common to each stamp supplier and the templates that the stamp supplier has originally created is provided to the purchaser. Therefore, the stamp suppliers who open the virtual stores in the electronic shopping mall can have their own originality different from that the other stamp suppliers have, being differentiated from the other stamp suppliers.

By posting a sample of a stamp face on the template information page, the stamp purchaser can readily understand the image of the stamp face of the product.

Further, the templates are posted on the template information page without differentiating between the common templates and the original templates. Therefore, products can sell without making a purchaser aware that a stamp that the purchaser is going to buy is a product that is commonly sold by a plurality of stamp suppliers or that is originally sold by a stamp supplier.

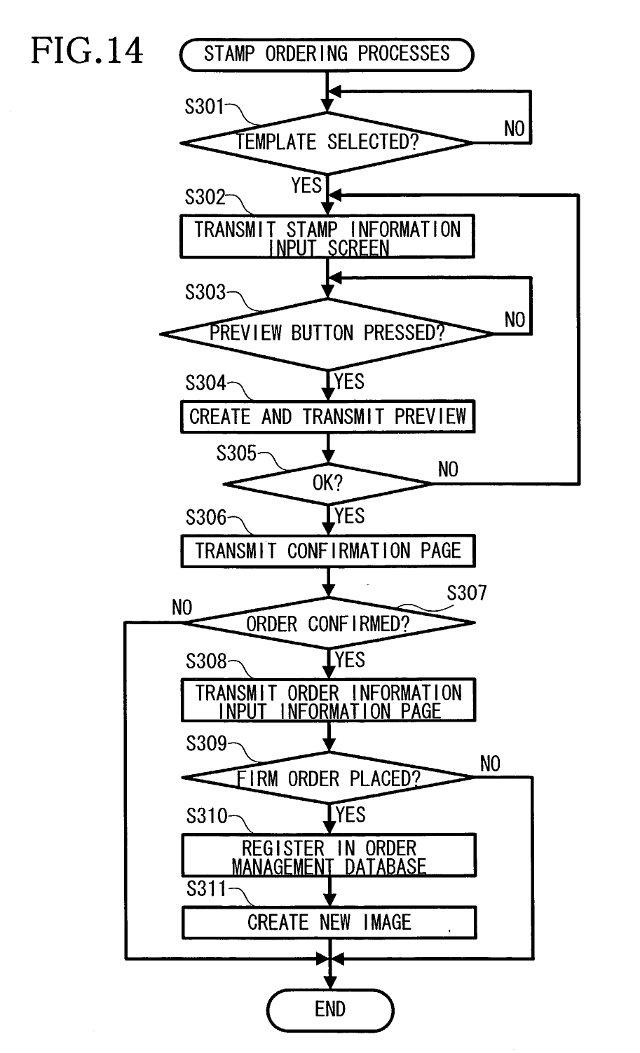

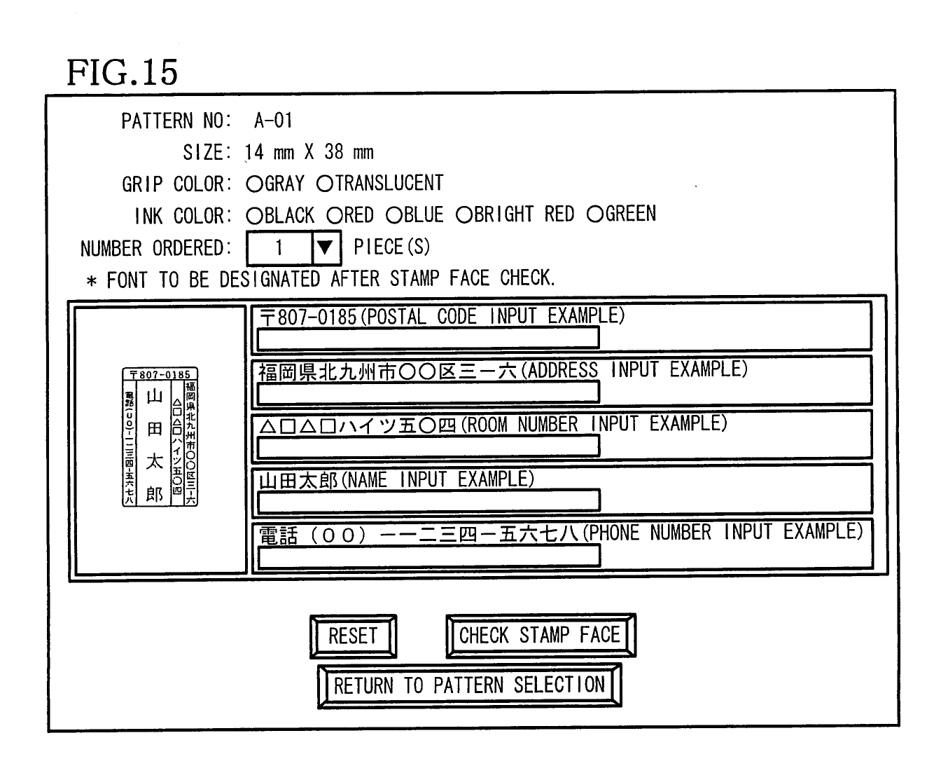

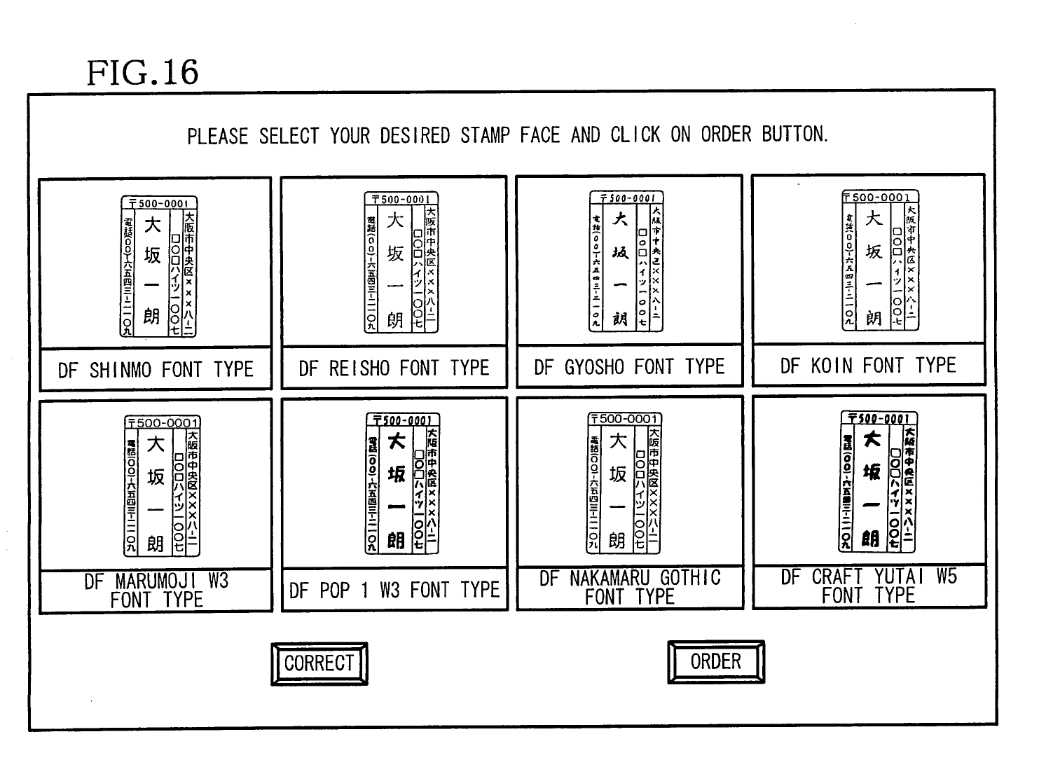

Next, stamp ordering processes to be performed by the purchaser subsequent to the flow shown in FIG. 10 will be described with reference to FIGS. 14 to 16. FIG. 14 is a flowchart showing stamp ordering processes in terms of processes in the server. FIGS. 15 and 16 are schematic view showing examples of pages displayed on the browser 31 of the computer 3 in one step of the stamp ordering processes.

In step S301, the input data analyzing portion 61 repeatedly determines whether a template is selected by the purchaser from a plurality of the templates displayed on the Web browser 31 of the computer 3, by clicking on a button for the desired template. What is displayed on the browser 31 of the purchaser is the template information page that is created in the template information page displaying processes shown in FIG. 10 and that shows the templates (common templates and original templates) of the products that the stamp supplier handles.

In step S302, a stamp information input page shown in FIG. 15 is extracted from the Web page database 9a and transmitted from the communication portion 5 to the purchaser computer 3, in accordance with the HTTP. On the stamp information input page illustrated in FIG. 15, input spaces are shown to input more specific stamp information (including grip color, ink color, number ordered, and character string data to be indicated on a stamp face, such as name and address) with respect to the template selected in step S301.

FIG. 15 is an example of the page to input characters and the like that the purchaser desires on the stamp face. In the page, a stamp face sample is shown. In addition, the page is structured such that the grip color, ink color, number ordered, and character information desired on the stamp face (postal code, address, name, and telephone number) can be selected or input.

In step S303, the input data analyzing portion 61 repeatedly determines whether a preview-viewing request button displayed on the browser 31 of the computer 3 is clicked on by the purchaser (that is, whether “CHECK STAMP FACE” button is pressed on the stamp information input screen shown in FIG. 15). When the preview-viewing request button in the browser 31 is clicked on, information input by the purchaser on the stamp information input page, such as that shown in FIG. 15, is received by the communication portion 5, via the Internet 10.

In step S304, the preview creating portion 81 of the image data creating portion 8 creates an preview image having a resolution of approximately 90 dpi, in accordance with the data input on the stamp information input page shown in FIG. 15. The created preview image is transmitted from the communication portion 5 to the purchaser computer 3, together with a HTML file (that may be extracted from the Web page database 9a) rewritten by the output data generating portion 62 so as to have link information for the preview image to be attached.

FIG. 16 is an indication example of the preview image and HTML file transmitted in step S304. In the example, a preview image is created in each of prescribed eight types of fonts, with respect to the template selected in step S301. A checkbox is provided in front of each of the eight font names. When ORDER button is pressed with any of the checkboxes checkmarked, the preview image in the font associated with the checkmark is selected as the stamp that the purchaser wishes to buy.

In step S305, the input data analyzing portion 61 determines whether the purchaser accepts the preview image transmitted in step S304, that is, whether ORDER button in the example of FIG. 16 is pressed with any of the checkboxes checkmarked. When it is determined that the purchaser accepts the preview image (S305:YES), flow proceeds to the process in step S306. When the purchaser does not accept the preview image (when CORRECT button in the example of FIG. 16 is pressed) (S305:NO), flow returns to the process in step S302 and the processes in steps S302 to S305 are repeated.

In step S306, an order confirmation page (including information such as the stamp template type, contents of text on the stamp face, and ink color) extracted from the Web page database 9a and rewritten by the output data generating portion 62 in accordance with the contents of the order, is transmitted to the purchaser computer 3.

In step S307, the input data analyzing portion 61 determines the contents of data transmitted from the purchaser. When data indicating the order confirmation is transmitted from the purchaser (S307:YES), flow goes to the process in step S308. When data indicating the order cancellation is transmitted (S307:NO), the stamp ordering processes end.

In step S308, an order information input page (including spaces for inputting the name and address of the stamp orderer, stamp delivery address, receiving method, delivery method, and payment method, and a space for indicating stamp costs) extracted from the Web page database 9a and rewritten by the output data generating portion 62 in accordance with the contents of the order, is transmitted to the purchaser computer 3.

In step S309, the input data analyzing portion 61 determines the contents of data transmitted from the purchaser. When the data indicating the firm order is transmitted from the purchaser (S309:YES), flow goes to the process in step S310. When the data indicating the order cancellation is transmitted (S309:NO), the stamp ordering processes end.

In step S310, the database management portion 9 issues an order number and sequentially stores in the order management database 9f, order information (name and address of the stamp orderer, stamp delivery address, receiving method, delivery method, payment method, and stamp costs), in association with the order number.

In step S311, upon the receipt of the firm order from the purchaser, the normal image creating portion 82 of the image data creating portion 8 creates, in accordance with the data input on the stamp information input page shown in FIG. 15, the normal image data with a resolution of approximately 600 dpi, that is used when the stamp is produced using the stamp producing device 24 connected to the supplier computer 2.

In the stamp ordering processes that have been described using the flowchart of FIG. 13, a desired product (stamp face, size, grip color, ink color, and font) is ordered using the template information page showing the templates (common templates and original templates) that the stamp supplier handles. Therefore, a product that a purchaser orders is definitely the stamp supplier's handling product. In addition, the purchaser can designate information to be printed on the stamp face, so that the stamp with characters, that the purchaser desires, printed can be ordered.

As described above, in the embodiment, the templates offered commonly to the stamp suppliers by the system administrator and the templates that a stamp supplier originally creates can be posted on the template information page of the stamp supplier who opens a virtual store in the electronic shopping mall. Therefore, it is featured that the stamp suppliers can readily construct the virtual stores using the common templates. Further, when stamps are sold to stamp purchasers, a stamp supplier can be differentiated from other suppliers, by having their originality different from the other stamp suppliers'.

While the preferred embodiment of the invention has been described above, the invention is not limited to the above-described embodiment. Various changes that fall within the scope of the claims can be made. For example, the invention can be applied to unique information indicating products, such as business cards, nameplates, and New Year's cards, other than stamps. Also, the online store management system of the invention is not limited to the above-described embodiment and, for example, the Web management portion and various databases may belong to separate computers. Further, the administrator computer 4 may be included in the sever computer 1. Changes in the sequence of each of the steps performed in the above-described embodiment, addition of another step, or elimination of a particular step may be performed, as long as such changes fall within the scope of the invention.

In the online store management system according to the invention, the common data is common sample image data and the original data is original sample image data. Because the sample image data is used as the data on the products, the purchaser can readily understand the image of the product appearance.

In the online store management system according to the invention, the editing means attaches the common data and the original data to a same Web page.

There is provided a product data providing method for providing data for providing data on products that one supplier or a plurality of suppliers sell, to a communication terminal of a purchaser through a communication network. The product data providing method according to the invention includes the step of transmitting common data on the products that are commonly sold by the plurality of the suppliers and original data on the products that are originally sold by each supplier, to the communication terminal of the purchaser, such that the common data and the original data are apparently indistinguishable by the purchaser. The common data and original data is shown to the purchaser seamlessly on the same Web page. Therefore, the products can sell without making the purchaser aware that the products which the purchaser is going to buy are products commonly sold by the plurality of the suppliers or originally sold by each supplier.

The online store management system according to the invention further includes a supplier ID storing means that stores an ID of each supplier in association with a password. The setting conditions of the original data for each supplier and the products associated with the original data can be prevented from being changed by other suppliers, by referring to the ID and the password according to the suppliers.

In the online store management system according to the invention, the products are unique information indicating products that indicate unique information. The unique information indicating products, such as stamps, business cards, nameplates, and New Year's cards, can be appropriately produced according to orders thereof. The unique information indicating products include stamps, business cards, and New Year's cards on which information of individuals or companies (e.g., names, addresses, postal codes, telephone numbers, and email addresses of individuals or companies) is indicated using a plate or by printing. In the invention, the unique information includes a variety of information, for example, personal information, such as names, addresses, postal codes, telephone numbers, and email addresses of individuals or groups of individuals, such as companies, as well as creative text, catch phrases, and combinations of symbols that have a particular meaning.

Accordingly, the sample image data is used as the data on the products, so that the purchaser can easily understand the image of the product appearance.

The common data and original data are shown to the purchaser on the same Web page seamlessly. Therefore, the products can sell without making the purchaser aware that the products which the purchaser is going to buy are products commonly sold by the plurality of the suppliers or originally sold by each supplier.

Further, by referring to the ID and the password according to the suppliers, the setting conditions of the original data for each supplier and the products associated with the original data can be prevented from being changed by other suppliers.

The unique information indicating products, such as stamps, business cards, nameplates, and New Year's cards, can be appropriately produced according to orders thereof.

As described above, according to the online store management system of the invention, it is very convenient for the suppliers to be able to readily accomplish Web pages for their own virtual stores using common data, and further for each supplier to be able to have their own originality using original data to be differentiated from other suppliers. Therefore, in an electronic shopping mall joining thereto a plurality of virtual stores particularly handling the same kinds of products, each of the stores can have their originality so as to drive purchasers to buy. Accordingly, uses of electronic shopping malls using communication networks, such as the Internet, can be widened.

What is claimed is:

1. An online store management system for providing data on products that one supplier or a plurality of suppliers sell, to a communication terminal of a purchaser through a communication network, comprising:
common data storing means that stores common data on the products that are commonly sold by the plurality of the suppliers;
original data storing means that stores original data on the products that are originally sold by each supplier;
setting condition storing means that updatably stores setting conditions of the common data, the products associated with the common data, the original data, and the products associated with the original data, for the each supplier; and
editing means that edits data to be transmitted to the communication terminal of the purchaser, based on settings stored in the setting condition storing means.

2. The online store management system as claimed in claim 1, wherein the common data is common sample image data and the original data is original sample image data.

3. The online store management system as claimed in claim 1, wherein the editing means attaches the common data and the original data to a same Web page.

4. The online store management system as claimed in claim 1, further comprising a supplier ID storing means that stores an ID of the each supplier in association with a password.

5. The online store management system as claimed in claim 1, wherein the products are unique information indicating products that indicate unique information.

6. A product data providing method for providing data for providing data on products that one supplier or a plurality of suppliers sell, to a communication terminal of a purchaser through a communication network, comprising:
transmitting common data on the products that are commonly sold by the plurality of the suppliers and original data on the products that are originally sold by each supplier, to the communication terminal of the purchaser, such that the common data and the original data are apparently indistinguishable by the purchaser.

7. A online store management server for providing data on products that one supplier or a plurality of suppliers sell, to a communication terminal of a purchaser through a communication network, comprising:
common data storing means that stores common data on the products that are commonly sold by the plurality of the suppliers;
original data storing means that stores original data on the products that are originally sold by each supplier;
setting condition storing means that updatably stores setting conditions of the common data, the products associated with the common data, the original data, and the products associated with the original data, for the each supplier; and
editing means that edits data to be transmitted to the communication terminal of the purchaser, based on settings stored in the setting condition storing means.

8. A computer-readable storage medium that stores a program to function an online store management system for providing data on products that one supplier or a plurality of suppliers sell, to a communication terminal of a purchaser through a communication network,
the program including:
a common data storing program for storing common data on the products that are commonly sold by the plurality of the suppliers;
an original data storing program for storing original data on the products that are originally sold by each supplier;
a setting condition storing program for updatably storing setting conditions of the common data, the products associated with the common data, the original data, and the products associated with the original data, for the each supplier; and
an editing program for editing data to be transmitted to the communication terminal of the purchaser, based on settings stored in the setting condition storing program.
